(19) United States
(12) Patent Application Publication
(10) Pub. No.: US 2024/0372904 A1
(43) Pub. Date: Nov. 7, 2024

(54) ENABLING VIRTUAL CONFERENCING WITHIN A VIRTUAL DESKTOP ENVIRONMENT

(71) Applicant: Zoom Video Communications, Inc., San Jose, CA (US)

(72) Inventors: Hongrui Huang, Hefei (CN); Guozhou Lu, Hangzhou (CN); Xingzhi Luo, Sunnyvale, CA (US); Fusheng Tian, Hefei (CN); Daoquan Ye, YiChun (CN)

(73) Assignee: Zoom Video Communications, Inc., San Jose, CA (US)

(21) Appl. No.: 18/778,662

(22) Filed: Jul. 19, 2024

Related U.S. Application Data
(63) Continuation of application No. PCT/CN2023/083887, filed on Mar. 24, 2023.

(51) Int. Cl. H04L 65/403; H04L 65/1069; H04L 65/1093

(52) U.S. Cl. CPC H04L 65/403; H04L 65/1069; H04L 65/1093

(57) ABSTRACT

An example method includes receiving, by a virtual conference provider from a first client application executed within a virtual desktop (“VD”) environment, a first request to join a meeting hosted by the virtual conference provider, the first request to join associated with a first participant; providing, by the virtual conference provider to the first client application, network information and meeting information associated with the meeting; connecting, by the virtual conference provider, the first client application to the meeting using a first connection; receiving, by the virtual conference provider from a second client application executed by a client device, a second request to join the meeting, the second request comprising at least a subset of the meeting information, the second request associated with the first participant; connecting, by the virtual conference provider, the second client application to the meeting based on the at least the subset of the meeting information using a second connection, the first client application and the second client application both corresponding to the first participant; associating the first connection and the second connection with the first participant; receiving, by the virtual conference provider, first meeting signaling information from the first client application and one or more first multimedia streams from the second client application; and providing, by the virtual conference provider, second meeting signaling information to the first client application and one or more second multimedia streams to the second client application

### CROSS REFERENCE PARAGRAPH FOR PRIORITY

This application is bypass continuation of PCT Application No. PCT/CN2023/083887, filed on Mar. 24, 2023, and titled “ENABLING VIRTUAL CONFERENCING WITHIN A VIRTUAL DESKTOP ENVIRONMENT,” which is hereby incorporated by reference in its entirety for all purposes.

### FIELD

The present application generally relates to virtual conference and more particularly relates to enabling virtual conferencing within a virtual desktop environment.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1-2 show example systems for enabling virtual conferencing within a virtual desktop environment;

FIGS. 3A-3B show an example system for enabling virtual conferencing within a virtual desktop environment;

FIG. 4 shows an example method for enabling virtual conferencing within a virtual desktop environment; and

FIG. 5 shows an example computing device suitable for use with systems and methods for enabling virtual conferencing within a virtual desktop environment.

### DETAILED DESCRIPTION

Examples are described herein in the context of enabling virtual conferencing within a virtual desktop environment. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Virtual conference providers can enable people to interact with each other using their own computers (or “client devices”) with both video and audio in a variety of settings, such as in one-on-one conversations, group meetings, and webinars. In many cases, people access their client devices and run a software application, generally referred to as a client application or client software, to allow them to join and participate in a virtual conference. When running on a user's client device, the client software can directly access a camera and microphone connected to the client device to obtain video and audio streams for the virtual conference. In addition, the client software communicates with the virtual conference provider to exchange signaling information to ensure the virtual conference is conducted in a coordinated manner.

However, in some cases, a user may need to engage in a virtual client while working in a virtual desktop (“VD”) environment. When use a virtual desktop, a user executes software on their client device that allows them to connect to a remote VD provider, which provides virtual machine (“VM”) that runs software the user can use to perform various tasks. VDs may be advantageous for remote employees who can connect to applications provided by their employer, but are not run on the user's own client device. By using the VD, the application can be run by the VD provider within the VM for the user, while they are connected to the VD. From the user's perspective, it appears that they are working directly with applications running on their own client device. Thus, the applications running at the VD provider provide views of the applications, e.g., their graphical user interfaces (“GUIs”), that the user can interact with. User inputs, such as keyboard or mouse inputs, are captured by their client device and communicated to the VD provider to control cursors or provide other inputs to the applications.

A difficulty for VD providers, however, is when a user attempts to engage in a virtual conference while running the virtual conference client software within a VD environment. Because the client software is executing within a VM on a VD provider server that is remote from the client device, all of the audio and video streams (collectively “multimedia streams”) captured by the user's camera and microphone must be first streamed to the client software running in the VM. The multimedia streams must then be transmitted to the virtual conference provider. Similarly, multimedia streams from other users are first streamed to the client software at the VD provider before being further streamed to the user's client device via the VD software and interface running at the client device. This consumes a significant amount of bandwidth between the user's client device and the VD provider, as well as between the VD provider and the virtual conference provider. In addition, this can introduce significant latency into the virtual conference for the user who has joined via the VD environment, which can reduce the quality of the virtual conference experience for that user.

To address these issues, a version of the client software installed at the VD provider may be configured to provide certain information about the virtual conference provider or the meeting to the user's client device to allow audio and video streams to be directly transmitted from the client device to the virtual conference provider, and from the virtual conference provider to the client device. Concurrently, the client software executed within the VM at the VD provider maintains the signaling connection with the virtual conference provider to maintain the user's connection to the virtual conference.

To enable this functionality, the client software at the VD provider is altered to obtain and provide network and participant information for multimedia streaming during the virtual conference. The user's client device executes software that will receive the network information and route captured multimedia streams directly to the virtual conference provider. In addition, the virtual conference provider employs a VD gateway to enable exchange of multimedia streams between the virtual conference provider and the user client device, while simultaneously allowing the virtual conference provider to exchange signaling and related information with the client software executed within the VM at the VD provider. Thus, the user is able to participate in virtual conferences from the VD, while directly exchanging multimedia streams with the virtual conference provider at the user device. This reduces the bandwidth requirements for the VD provider and reduces latency in delivery of multimedia streams between the user's client device and the virtual conference provider.

This illustrative example is given to introduce the reader to the general subject matter discussed herein and the disclosure is not limited to this example. The following sections describe various additional non-limiting examples and examples of enabling virtual conferencing within a virtual desktop environment.

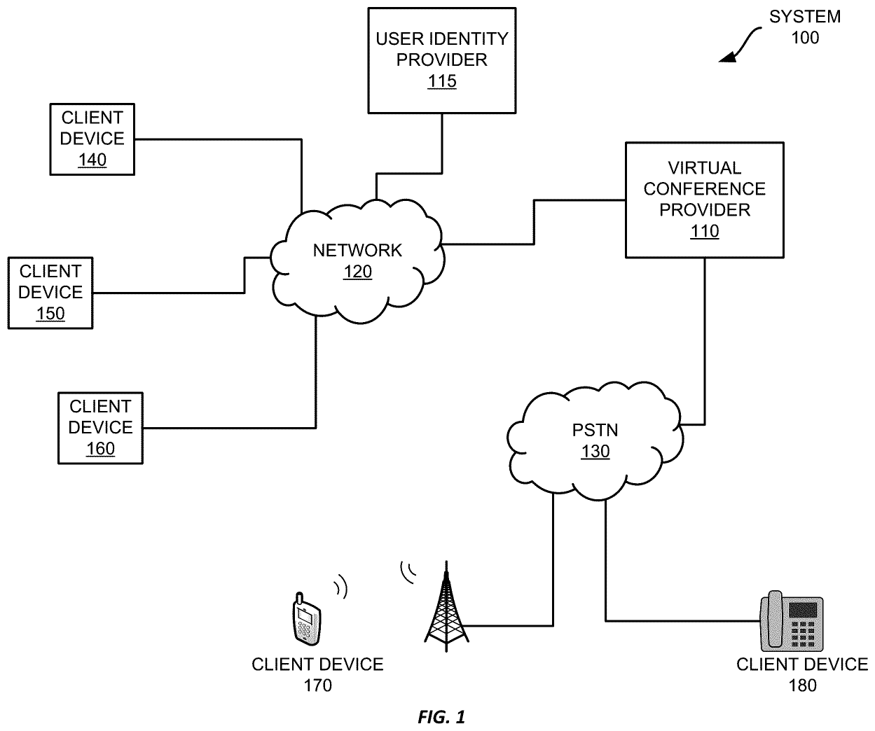

Referring now to FIG. 1, FIG. 1 shows an example system 100 that provides videoconferencing functionality to various client devices. The system 100 includes a virtual conference provider 110 that is connected to multiple communication networks 120, 130, through which various client devices 140-180 can participate in virtual conferences hosted by the virtual conference provider 110. For example, the virtual conference provider 110 can be located within a private network to provide video conferencing services to devices within the private network, or it can be connected to a public network, e.g., the internet, so it may be accessed by anyone. Some examples may even provide a hybrid model in which a virtual conference provider 110 may supply components to enable a private organization to host private internal virtual conferences or to connect its system to the virtual conference provider 110 over a public network.

The system optionally also includes one or more user identity providers, e.g., user identity provider 115, which can provide user identity services to users of the client devices 140-160 and may authenticate user identities of one or more users to the virtual conference provider 110. In this example, the user identity provider 115 is operated by a different entity than the virtual conference provider 110, though in some examples, they may be the same entity.

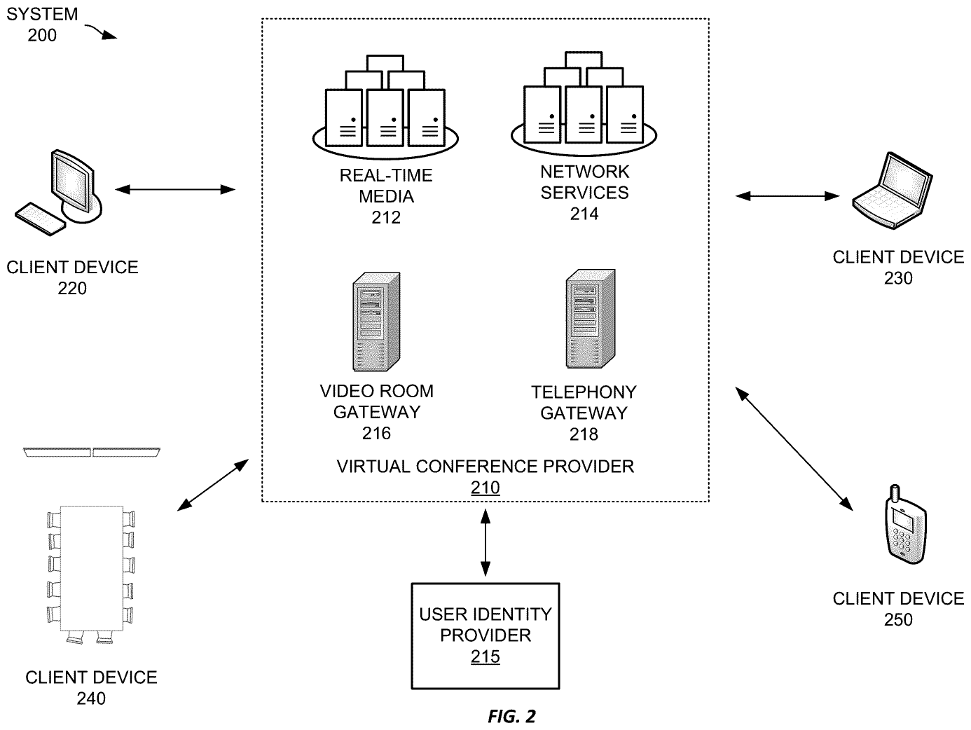

Virtual conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the virtual conference provider 110.

Meetings in this example virtual conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the virtual conference provider 110, a user may contact the virtual conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the virtual conference provider 110 may prompt the user for certain information, such as a date, time, and duration for the meeting, a number of participants, a type of encryption to use, whether the meeting is confidential or open to the public, etc. After receiving the various meeting settings, the virtual conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The virtual conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the virtual conference provider 110. They also receive audio or video information from the virtual conference provider 110, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The virtual conference provider 110 may also invalidate the meeting information, such as the meeting identifier or password/passcode.

To provide such functionality, one or more client devices 140-180 may communicate with the virtual conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the virtual conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a virtual conference meeting hosted by the virtual conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the virtual conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the virtual conference provider 110 using network 120 and may provide information to the virtual conference provider 110 to access functionality provided by the virtual conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the virtual conference provider 110.

A user identity provider 115 may be any entity trusted by the virtual conference provider 110 that can help identify a user to the virtual conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the virtual conference provider 110.

When the user accesses the virtual conference provider 110 using a client device, the virtual conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the virtual conference provider 110 either provides or denies access to its services, respectively.

For telephony devices, e.g., client devices 170-180, the user may place a telephone call to the virtual conference provider 110 to access virtual conference services. After the call is answered, the user may provide information regarding a virtual conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the virtual conference provider 110. For example, telephony devices may be unable to provide user identification information to identify the telephony device or the user to the virtual conference provider 110. Thus, the virtual conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the virtual conference provider 110, even in cases where the user has an authenticated identity and employs a client device capable of identifying the user to the virtual conference provider 110. The virtual conference provider 110 may determine whether to allow such anonymous users to use services provided by the virtual conference provider 110. Anonymous users, regardless of the reason for anonymity, may be restricted as discussed above with respect to users employing telephony devices, and in some cases may be prevented from accessing certain meetings or other services, or may be entirely prevented from accessing the virtual conference provider 110.

Referring again to virtual conference provider 110, in some examples, it may allow client devices 140-160 to encrypt their respective video and audio streams to help improve privacy in their meetings. Encryption may be provided between the client devices 140-160 and the virtual conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the virtual conference provider 110, while allowing the virtual conference provider 110 to access the decrypted multimedia streams to perform certain processing, such as recording the meeting for the participants or generating transcripts of the meeting for the participants. End-to-end encryption may be used to keep the meeting entirely private to the participants without any worry about a virtual conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the virtual conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a virtual conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the virtual conference provider 210 over a communications network, such as the internet for client devices 220-240 or the PSTN for client device 250, generally as described above with respect to FIG. 1. The virtual conference provider 210 is also in communication with one or more user identity providers 215, which can authenticate various users to the virtual conference provider 210 generally as described above with respect to FIG. 1.

In this example, the virtual conference provider 210 employs multiple different servers (or groups of servers) to provide different aspects of virtual conference functionality, thereby enabling the various client devices to create and participate in virtual conference meetings. The virtual conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more virtual conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the virtual conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the virtual conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the virtual conference provider 210 may receive multimedia streams from the various participants and publish those streams to the various participants to subscribe to and receive. Thus, the virtual conference provider 210 notifies a client device, e.g., client device 220, about various multimedia streams available from the other client devices 230-250, and the client device 220 can select which multimedia stream(s) to subscribe to and receive. In some examples, the virtual conference provider 210 may provide to each client device the available streams from the other client devices, but from the respective client device itself, though in other examples it may provide all available streams to all available client devices. Using such a multiplexing technique, the virtual conference provider 210 may enable multiple different streams of varying quality, thereby allowing client devices to change streams in real-time as needed, e.g., based on network bandwidth, latency, etc.

As mentioned above with respect to FIG. 1, the virtual conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the virtual conference provider 210 may allow a meeting participant to notify it of inappropriate behavior or content in a meeting. Such a notification may trigger the real-time media servers to 212 record a portion of the meeting for review by the virtual conference provider 210. Still other functionality may be implemented to take actions based on the decrypted multimedia streams at the virtual conference provider 210, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the virtual conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the virtual conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the virtual conference provider 210 under a supervisory set of servers. When a client device 220-250 accesses the virtual conference provider 210, it will typically communicate with one or more network services servers 214 to access their account or to participate in a meeting.

When a client device 220-250 first contacts the virtual conference provider 210 in this example, it is routed to a network services server 214. The client device may then provide access credentials for a user, e.g., a username and password or single sign-on credentials, to gain authenticated access to the virtual conference provider 210. This process may involve the network services servers 214 contacting a user identity provider 215 to verify the provided credentials. Once the user's credentials have been accepted, the client device 214 may perform administrative functionality, like updating user account information, if the user has an identity with the virtual conference provider 210, or scheduling a new meeting, by interacting with the network services servers 214.

In some examples, users may access the virtual conference provider 210 anonymously. When communicating anonymously, a client device 220-250 may communicate with one or more network services servers 214 but only provide information to create or join a meeting, depending on what features the virtual conference provider 210 allows for anonymous users. For example, an anonymous user may access the virtual conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the virtual conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the virtual conference provider 210. For example, the video conferencing hardware may be provided by the virtual conference provider 210 to one or more of its subscribers, which may provide access credentials to the video conferencing hardware to use to connect to the virtual conference provider 210.

The video room gateway servers 216 provide specialized authentication and communication with the dedicated video conferencing hardware that may not be available to other client devices 220-230, 250. For example, the video conferencing hardware may register with the virtual conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the virtual conference provider 210.

Referring now to the telephony gateway servers 218, these servers 218 enable and facilitate telephony devices' participation in meetings hosed by the virtual conference provider 210. Because telephony devices communicate using the PSTN and not using computer networking protocols, such as TCP/IP, the telephony gateway servers 218 act as an interface that converts between the PSTN and the networking system used by the virtual conference provider 210.

For example, if a user uses a telephony device to connect to a meeting, they may dial a phone number corresponding to one of the virtual conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the virtual conference provider 210 discussed above are merely examples of such devices and an example architecture. Some virtual conference providers may provide more or less functionality than described above and may not separate functionality into different types of servers as discussed above. Instead, any suitable servers and network architectures may be used according to different examples.

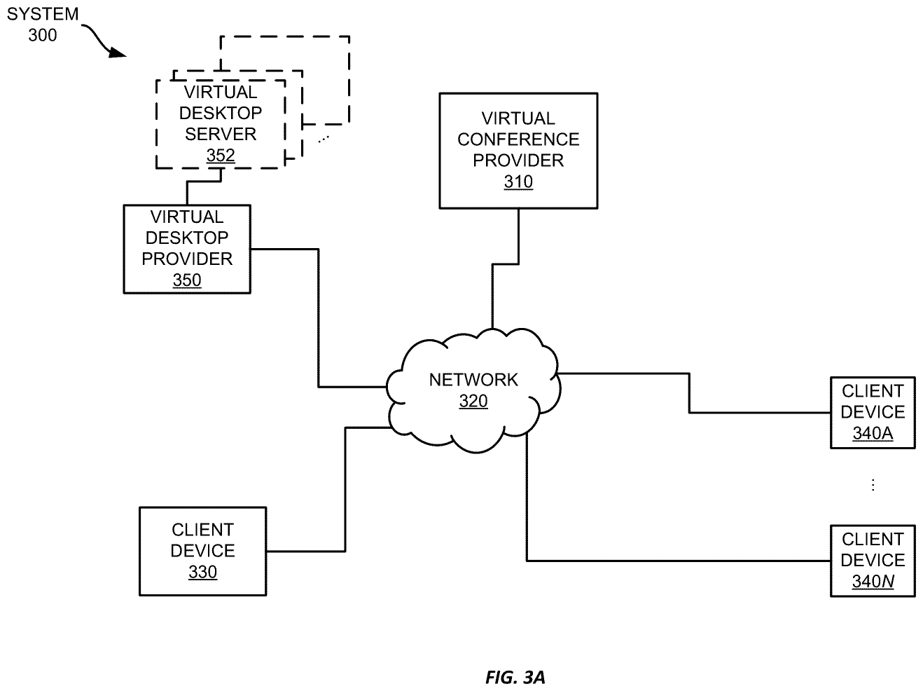

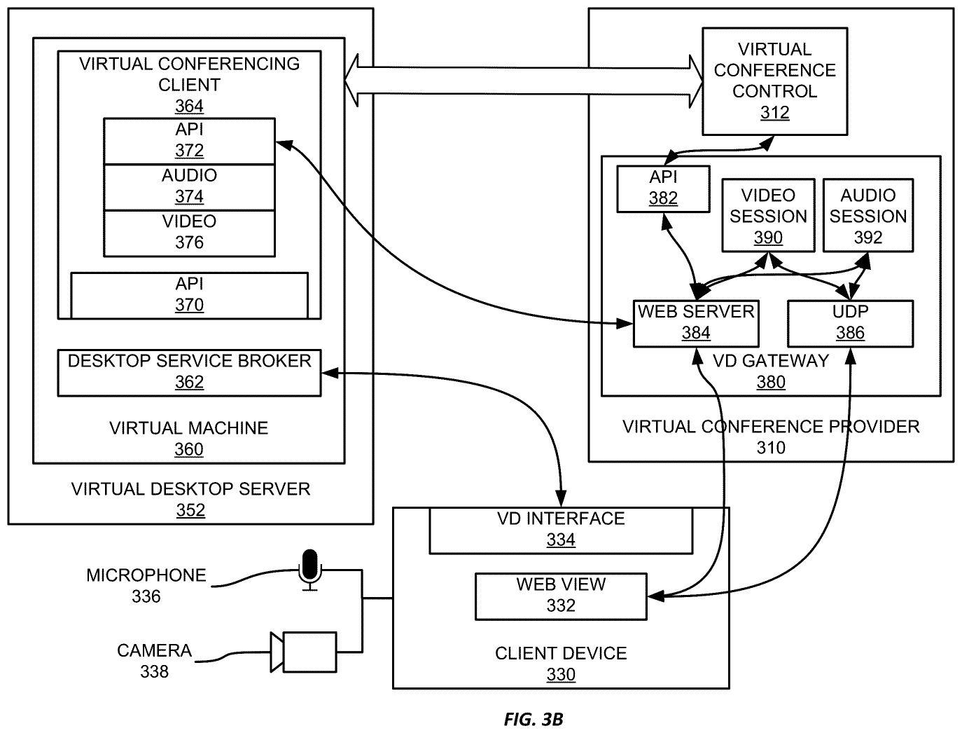

Referring now to FIG. 3A, FIG. 3A shows an example system 300 for enabling virtual conferencing within a virtual desktop environment. In this example system 300, a number of client devices 330, 340a-n are participating in a virtual conference hosted by a virtual conference provider 310 via a communications network 320. In this example, the communications network 320 is the internet, however, any suitable communications network or combination of communications network may be employed, including LANs (e.g., within a corporate private LAN), WANs, etc.

Each client device 330, 340a-n executes video conference software, which connects to the video conference provider 310 and joins a meeting. During the meeting, the various participants (using video conference software at their respective client devices 330, 340a-n) are able to interact with each other to conduct the meeting, such as by viewing video streams and hearing audio streams from other participants, and by capturing and transmitting video and audio of themselves.

However, client device 330 is connected to the VD provider 350 via the network 320. The VD provider 350 operates a number of VD servers 352 to provide various VD functionality to its customers, including remote execution environments and applications. In this example, client device 330 has initiated a VD session with the VD provider 350, which has allocated a VD server 352 to provide an execution environment—a VM executing a desired operating system, in this example—as well as various available applications to the client device 330, including virtual conference client software (“client software”). The client device 330 has executed the client software within the VD server 352 and has connected to the virtual conference using the remotely executed client software. As discussed above, this presents potential latency issues for the client device 330 as well as bandwidth consumption issues for the VD provider 350. To address these issues, the virtual conference provider 310, the VD provider 350, and the client device 330 execute software to enable multimedia streams exchanged within the virtual conference to be exchanged directly between the client device 330 and the virtual conference provider 310, while virtual meeting signaling is exchanged between the VD server 352 executing the client software at the VD provider 350.

Referring now to FIG. 3B, FIG. 3B provides another view of the system 300 shown in FIG. 3A. In this Figure, more detailed views of the virtual conference provider 310, the client device 330, and a VD server 352 are provided. As can be seen, the VD server 352 provides a VM 360 for the user of the client device 330 to execute various applications. In this case, the user has launched a virtual conferencing client 364 that includes audio and video functionality 374, 376 as well as an application programming interface (“API”) 372 to enable communications with the virtual conference provider 310. The client software 364 also includes a second API 370 that interacts with the VM 360 and the desktop service broker 362 to communicate with the user's client device 330.

The user's client device 330 provides a web view application 332 that enables the user to interact with the applications executed within the VD, such as the software client 364. The web view application 332 employs the VD interface 334 to communicate with the desktop service broker 362 to provide audio and video information from the applications running in the VM 360 to the web view application 332 and to provide user interface interactions to the VM 360. In addition, the web view application 332 is able to receive audio and video signals from the microphone 336 and camera 338 that are connected to the client device 330.

The virtual conference provider 310 provides virtual conference control functionality 312 to enable client software 364 to connect to the virtual conference provider 310 and to obtain information needed to join and participate in virtual conferences. The virtual conference control functionality 312 provides signaling functionality to provide information to client devices about how to communicate with the virtual conference provider during a virtual conference (or “meeting”), such as by providing network address information for servers to send and receive multimedia streams, provide information about other participants in the meeting, settings established for the meeting, etc. In addition, the virtual conference control functionality 312 can send and receive multimedia streams to clients connected to meetings. However, in this example, as will be discussed in more detail, multimedia streams will instead be sent to the client device 330 via the VD gateway 380, rather than directly from the virtual conference control 312.

The virtual conference provider 310 also provides a VD gateway 380 to enable direct exchange of multimedia streams with the client device 330 in cases where a user is connected to a meeting via client software executed in a VD environment. The VD 380 gateway communicates with the client device 330 via its web server 384 to establish and maintain communications. Communications via the web server 384 are typically via a connection-oriented protocol, such as the transmission control protocol (“TCP”). For audio and video streams, however, connectionless protocols, such as the user datagram protocol (“UDP”), may be used. When a client device connects to a meeting via a VD environment, the client device 330 communicates with the VD gateway 380 to establish audio and video sessions 390, 392 at a multimedia server of the virtual conference provider 310, through which audio and video streams will be exchanged with the meeting. Thus, both connection-oriented communications with the web server 384 and connectionless communications with the multimedia sessions 390-392 will be employed.

When the user wishes to join a virtual conference using the software client 364 executed at the VD server 352, they launch the client software 364 and provide meeting information, such as a meeting identifier (“ID”) and passcode, as well as participant information such as a username and password. The software client 364 then communicates with the virtual conference provider 310 to connect to the meeting and to obtain network information for the server(s) that will handle multimedia streams. Ordinarily, the software client 364 would use the network information to begin receiving and sending multimedia streams. However, in this example, the software client 364 is configured to provide the network information and participant information, such as a username and password or user identity, to the web view application 332 executed at the client software, via the API 370 and desktop service broker 362. In addition, the software client 364 provides meeting information to the web view application 332, such as a meeting ID, password, and participant ID, to enable the web view application 332 to capture and provide audio or video streams to the meeting associated with the connection between the client software 364 executing in the VD environment and the video conference provider 310.

The web view application 332 receives the network information from the client software 364 and transmits information to the virtual conference provider 310 to connect to the same virtual conference as the software client 364. In this example, the client software 322 connects to the virtual conference provider 310 via the webserver 384 in the VD gateway 380 and provides the network information and meeting information. The web server 384 in turn communicates with the virtual conference control 312 via an API 382 to establish one or more connections for audio and video sessions 390, 392 via the multimedia server for the meeting. The client software 364 then communicates with the virtual conference control 312 to manage the user's participation in the meeting, such as by maintaining sync with the signaling for the meeting, to receive information about other participants in the meeting, to join or leave breakout rooms, or other functionality provided by the virtual conference control 312.

Once the connection has been established by the software client 364, the web server 384 provides available audio and video streams from the meeting to the web view application 332. In addition, the web view application 332 accesses the microphone 336 and camera 338 to allow the user of the client device 330 to interact with other participants in the meeting. Captured audio and video streams from the microphone 336 and camera 338 are transmitted using a connectionless protocol, e.g., UDP in this example, to the VD gateway 380 and to the audio and video sessions 390, 392. The data from those sessions 390, 392 is then provided by the web server 384 to the meeting via the virtual conference control 312. Similarly, video and audio streams are provided from the meeting by the virtual conference control 312 as a part of the audio and video sessions 390, 392, which are communicated to the web view application 332 using the UDP protocol in this example.

Thus, by employing the VD gateway 380, the user is able to engage in a virtual conference hosted by the virtual conference provider 310 while working in a VD environment, but without burdening the VD provider 350 with the added bandwidth costs of receiving and transmitting large volumes of multimedia data. Instead, the multimedia streams are directly transmitted and received between the client device 330 and the virtual conference provider 310, while the meeting management and control is handled by the client software 364 executing within the VD environment, e.g., a VM 360, at the VD provider 350. It should be appreciated that while this example system 300 employs a discrete VD gateway 380, it should be appreciated that the VD gateway 380 may be a dedicated computing device or software application in some examples, while in some examples, the VD gateway functionality discussed herein may be distributed across different software applications and computing devices within the virtual conference provider 310 without a dedicated computing device or software application.

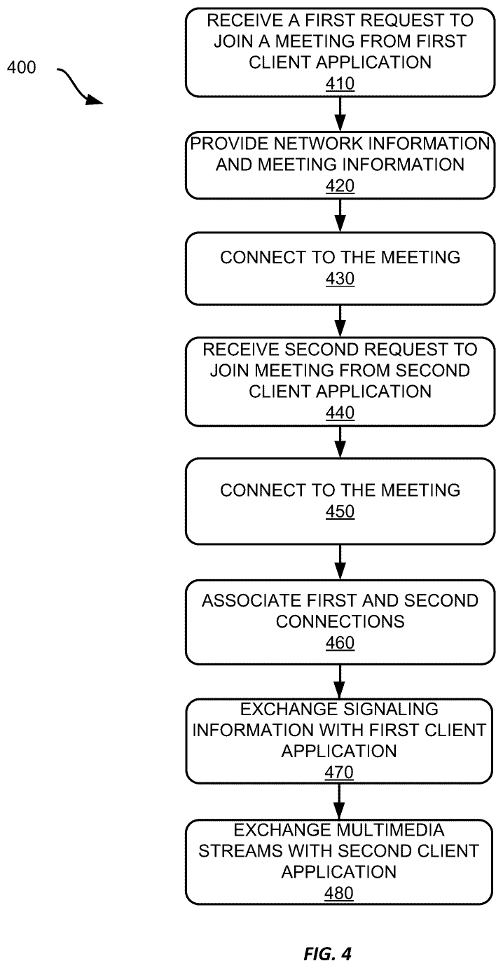

Referring now to FIG. 4, FIG. 4 shows an example method for enabling virtual conferencing within a VD environment. The example method 400 will be discussed with respect to the example system 300 shown in FIGS. 3A-3B; however, any suitable system according to this disclosure may be employed.

At block 410, the virtual conference provider 310 receives a first request to join a meeting hosted by the virtual conference provider from a first client application. In this example, the first client application comprises the client software 364 that is executed in a VD environment. As discussed above with respect to FIG. 3B, the client software 364 is executed within a VM 360 provided by a VD server 352 of a VD provider 350. However, any first client application executing within a remote execution environment from a user's client device, e.g., client device 330, may be employed. In addition, the first request is received by a virtual conference control 312 of the virtual conference provider 310.

In this example, the first request also includes participant information associated with the user of the client device 330. For example, the participant information may be a participant ID, or it may be a username and password for a user account associated with the user of the client device 330. In some examples, the participant information may be a user identity, such as may be obtained or verified with a user identity provider 115, 215.

At block 420, the virtual conference provider 310 provides network information and meeting information associated with the meeting to the first client application. In this example, the network information comprises a network address of a multimedia server of the virtual conference provider and the meeting information includes information about one or more participants in the meeting, a meeting type, and one or more meeting settings.

At block 430, the virtual conference provider 310 connects the first client application to the meeting using a first connection. In this example, the first connection comprises a connection-based connection, such as a TCP connection. Such a connection may allow the first client application and the virtual conference provider to exchange signaling to enable the first and second client applications to jointly participate in the meeting.

At block 440, the virtual conference provider 310 receives a second request to join the meeting from a second client application. In this example, the second client application is executed by a client device remote from the VD environment that executes the first client application. In addition, the second client application in this example is a web-based application, such as the web view application 332 shown in FIG. 3B. The second request includes at least a part of the network information provided to the first client application at block 420. In addition, in this example, the second request also includes participant information, such as the participant information discussed above with respect to block 410; however, the participant information included in the second request may include different information from the first request. For example, the second request may include a participant ID assigned by the virtual conference provider 310 that was not included in the first request because a participant ID may not have been assigned at that time. Further, in this example, the second request is received by a VD gateway 380 of the virtual conference provider 310; however, it should be appreciated that a VD gateway 380 is not required.

At block 450, the virtual conference provider 310 connects the second client application to the meeting using a second connection. In this example, the second connection is configured to enable exchange of multimedia streams, such as audio and video streams, between the meeting and the client device 330. In this example the second connection includes one or more UDP connections, but may include other types of connections. In addition, the second connection may be based on the network information received as a part of the second request. The network information may enable one or more connections with a multimedia server within the virtual conference provider 310 to enable exchange of one or more multimedia streams between the meeting and the client device 330. In this example, the VD gateway 380 establishes a connection with the multimedia server, which provides audio and video sessions 390, 392 corresponding to the meeting. In addition, the VD gateway 380 establishes a connection to the virtual conference control 312 to exchange signaling to coordinate between the first client application 364 and the second client application 332.

At block 460, the virtual conference provider 310 associates the first and second connections with the first participant. As discussed above, the participant connects to the meeting via both the first client application, which is executed remotely in a VD environment, and the second client application, which is executed locally on the user's client device 330. In this example, the virtual conference provider associates the first and second connections with the participant based on the participant information received in the first and second requests. By associating the first and second connections, the virtual conference provider 310 is able to exchange multimedia streams with a client application executing on one computing device, such as the client device 330, while exchanging signaling information, such as meeting control information, with another client application executing on another computing device, such as the VD server 352.

At block 470, the virtual conference provider 310 exchanges signaling information with the client software 364 executing within the VD environment using the first connection.

At block 480, the virtual conference provider 310 exchanges multimedia streams with the web view application 332 executing at the client device 330.

By associating the first and second connections, the virtual conference provider 310 is able to exchange multimedia streams with a client application executing on one computing device, such as the client device 330, while exchanging signaling information, such as meeting control information, with another client application executing on another computing device, such as the VD server 352. Thus, the three computing devices are able to effectively coordinate the user's participation in the virtual conference.

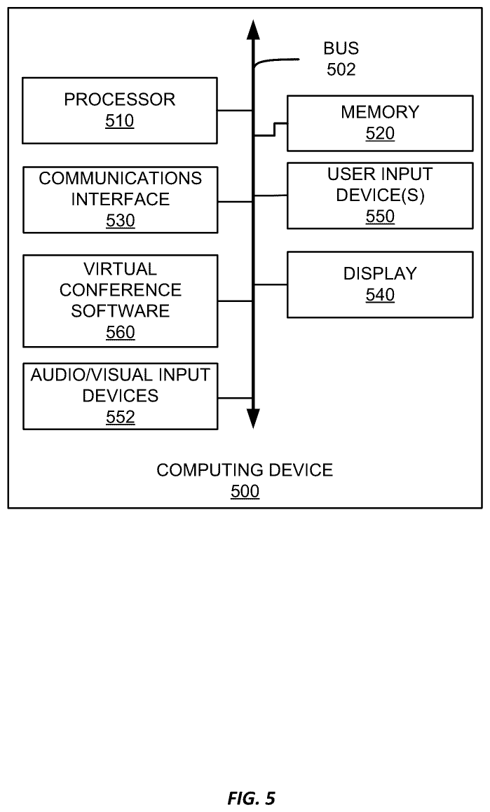

Referring now to FIG. 5, FIG. 5 shows an example computing device 500 suitable for use in example systems or methods for protecting private information in a chat system according to this disclosure. The example computing device 500 includes a processor 510 which is in communication with the memory 520 and other components of the computing device 500 using one or more communications buses 502. The processor 510 is configured to execute processor-executable instructions stored in the memory 520 to perform one or more methods for protecting private information in a chat system according to different examples, such as part or all of the example method 400 described above with respect to FIG. 4. The computing device 500, in this example, also includes one or more user input devices 550, such as a keyboard, mouse, touchscreen, microphone, etc., to accept user input. The computing device 500 also includes a display 540 to provide visual output to a user.

In addition, the computing device 500 includes a virtual conferencing application 560 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 500 also includes a communications interface 540. In some examples, the communications interface 530 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
receiving, by a virtual conference provider from a first client application executed within a virtual desktop (“VD”) environment, a first request to join a meeting hosted by the virtual conference provider, the first request to join associated with a first participant;
providing, by the virtual conference provider to the first client application, network information and meeting information associated with the meeting;
connecting, by the virtual conference provider, the first client application to the meeting using a first connection;
receiving, by the virtual conference provider from a second client application executed by a client device, a second request to join the meeting, the second request comprising at least a subset of the meeting information, the second request associated with the first participant;
connecting, by the virtual conference provider, the second client application to the meeting based on the at least the subset of the meeting information using a second connection, the first client application and the second client application both corresponding to the first participant;
associating the first connection and the second connection with the first participant;
receiving, by the virtual conference provider, first meeting signaling information from the first client application and one or more first multimedia streams from the second client application; and
providing, by the virtual conference provider, second meeting signaling information to the first client application and one or more second multimedia streams to the second client application.

2. The method of claim 1, further comprising associating the first signaling information and the one or more first multimedia streams.

3. The method of claim 1, wherein the virtual conference provider comprises virtual conference control and a VD gateway, and wherein the first request is received by the virtual conference control and the second request is received by the VD gateway, and wherein the VD gateway communicates with the virtual conference control to associate the first and second connections.

4. The method of claim 3, wherein the virtual conference control provides the one or more second multimedia streams to the VD gateway, and the VD gateway provides the one or more second multimedia streams to the client device.

5. The method of claim 3, wherein the virtual conference control provides the one or more second signaling streams to the first client application.

6. The method of claim 3, wherein the VD gateway provides the second multimedia streams using a connectionless network protocol.

7. The method of claim 3, wherein the network information and meeting information comprises a network address of a multimedia server of the virtual conference provider.

8. A system comprising:
a communications interface;
a non-transitory computer-readable medium; and
one or more processors communicatively coupled to the communications interface and the non-transitory computer-readable medium, the one or more processors configured to execute processor-executable instructions stored in the non-transitory computer-readable medium to:
receive, by a virtual conference provider from a first client application executed within a virtual desktop (“VD”) environment, a first request to join a meeting hosted by the virtual conference provider, the first request to join associated with a first participant;
provide, by the virtual conference provider to the first client application, network information and meeting information associated with the meeting;
connect, by the virtual conference provider, the first client application to the meeting using a first connection;
receive, by the virtual conference provider from a second client application executed by a client device, a second request to join the meeting, the second request comprising at least a subset of the meeting information, the second request associated with the first participant;
connect, by the virtual conference provider, the second client application to the meeting based on the at least the subset of the meeting information using a second connection, the first client application and the second client application both corresponding to the first participant;
associate the first connection and the second connection with the first participant;
receive, by the virtual conference provider, first meeting signaling information from the first client application and one or more first multimedia streams from the second client application; and
provide, by the virtual conference provider, second meeting signaling information to the first client application and one or more second multimedia streams to the second client application.

9. The system of claim 8, further comprising associating the first signaling information and the one or more first multimedia streams.

10. The system of claim 8, wherein the virtual conference provider comprises virtual conference control and a VD gateway, and wherein the first request is received by the virtual conference control and the second request is received by the VD gateway, and wherein the VD gateway communicates with the virtual conference control to associate the first and second connections.

11. The system of claim 10, wherein the virtual conference control provides the one or more second multimedia streams to the VD gateway, and the VD gateway provides the one or more second multimedia streams to the client device.

12. The system of claim 10, wherein the virtual conference control provides the one or more second signaling streams to the first client application.

13. The system of claim 10, wherein the VD gateway provides the second multimedia streams using a connectionless network protocol.

14. The system of claim 10, wherein the network information and meeting information comprises a network address of a multimedia server of the virtual conference provider.

15. A non-transitory computer-readable medium comprising processor-executable instructions configured to cause one or more processors to:
receive, by a virtual conference provider from a first client application executed within a virtual desktop (“VD”) environment, a first request to join a meeting hosted by the virtual conference provider, the first request to join associated with a first participant;
provide, by the virtual conference provider to the first client application, network information and meeting information associated with the meeting;
connect, by the virtual conference provider, the first client application to the meeting using a first connection;
receive, by the virtual conference provider from a second client application executed by a client device, a second request to join the meeting, the second request comprising at least a subset of the meeting information, the second request associated with the first participant;
connect, by the virtual conference provider, the second client application to the meeting based on the at least the subset of the meeting information using a second connection, the first client application and the second client application both corresponding to the first participant;
associate the first connection and the second connection with the first participant;
receive, by the virtual conference provider, first meeting signaling information from the first client application and one or more first multimedia streams from the second client application; and
provide, by the virtual conference provider, second meeting signaling information to the first client application and one or more second multimedia streams to the second client application.

16. The non-transitory computer-readable medium of claim 15, further comprising associating the first signaling information and the one or more first multimedia streams.

17. The non-transitory computer-readable medium of claim 15, wherein the virtual conference provider comprises virtual conference control and a VD gateway, and wherein the first request is received by the virtual conference control and the second request is received by the VD gateway, and wherein the VD gateway communicates with the virtual conference control to associate the first and second connections.

18. The non-transitory computer-readable medium of claim 17, wherein the virtual conference control provides the one or more second multimedia streams to the VD gateway, and the VD gateway provides the one or more second multimedia streams to the client device.

19. The non-transitory computer-readable medium of claim 17, wherein the virtual conference control provides the one or more second signaling streams to the first client application.

20. The non-transitory computer-readable medium of claim 17, wherein the VD gateway provides the second multimedia streams using a connectionless network protocol.
